(19) United States
(12) Patent Application Publication
(10) Pub. No.: US 2006/0079144 A1
(43) Pub. Date: Apr. 13, 2006

(54) Plastic substrate and method for the production thereof

(75) Inventors: Thomas Klisch, Muenchen (DE); Georg Hawlitzki, Neufahrn (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/287,221

(22) Filed: Nov. 28, 2005

Related U.S. Application Data
(63) Continuation of application No. PCT/EP04/04195, filed on Apr. 21, 2004.

(30) Foreign Application Priority Data
May 28, 2003 (DE) 103 24 248.1

(51) Int. Cl. B32B 5/02; H05B 6/00

(52) U.S. Cl. 442/59; 264/478

(57) ABSTRACT

A method for producing a plastic substrate for an interior paneling part of a motor vehicle and the resulting plastic substrate. The plastic substrate has a flap for the passage of an airbag. The hinge areas of the lid are reinforced by a mesh fabric part. Preferably the fabric part has a wide mesh. During production, the fabric part is first inserted in the injection mold in the position of the future flap. During the subsequent injection molding, the plastic mass presses the fabric part on the one side against the interior mold wall, but also penetrates it through the wide mesh structure. After casting, tear lines, which define the opening contour of the flap, are produced, preferably by laser beam machining. Further, fabric sections situated outside the hinge areas may be severed and the plastic areas situated behind them weakened.

### CROSS-REFERENCE TO RELATED APPLICATIONS

This application is a continuation of International Patent Application No. PCT/EP2004/004195, filed Apr. 21, 2004, designating the United States of America, and published in German as WO2004106121, the entire disclosure of which is incorporated herein by reference. Priority is claimed based on German Application No. DE20031024248, filed May 28, 2003.

### BACKGROUND AND SUMMARY OF THE INVENTION

The invention relates to a plastic substrate and to a method for the production thereof.

The plastic substrates may be used for interiors of vehicle doors or vehicle body sections. They may also be components of vehicle seats or instrument panels, etc. In a vehicle occupant compartment, they are usually laminated with a foam-coated foil. These plastic substrates may have an opening flap in common with the airbag of an airbag unit situated behind it.

German Patent Document DE 44 18 172 A1 shows a technique for linking the flap to the plastic substrate of an instrument panel. The flap forms an integral component of the plastic substrate, and a seam, which forms the opening contour, separates the flap, with the exception of a hinge area, from the actual substrate. The hinge area is underlaid with a reinforcing strip made of a flexible tear-resistant material. The flap changes in one piece into the plastic substrate. During production, the plastic substrate is laminated with a foil situated in the vehicle occupant's visual range and, in a further operation, the reinforcing strip is applied to the hinge area. This additional operation considerably increases the cost of the production.

One object of certain embodiments of the invention is to simplify the production of a plastic substrate of the above-mentioned type.

According to the invention, this object is achieved by means of a method of producing a plastic substrate for an interior paneling part of a motor vehicle, wherein a plastic substrate with an integral flap for the passage of an airbag is produced by injection molding. The flap is swivellable in the opening direction by way of a hinge provided on the plastic substrate, and the hinge is reinforced by a fabric part, wherein the fabric part has a mesh structure. The method comprises the steps of: inserting the hinge into an injection mold at least in the hinge area of the future flap, closing of the mold, forming a molten plastic for forming a plastic substrate injecting the molten plastic so that the molten plastic presses the fabric part against a mold wall and penetrates through the mesh structure of the fabric.

In another embodiment, a plastic substrate, produced according to the method described above, which, as part of an interior paneling of a motor vehicle, has an integral two-leaf flap for the passage of an airbag upon its triggering, the hinge areas of the flap are reinforced with a fabric part which is injection-molded in the plastic substrate, with tear line, which define the opening contour of the flap, and which are produced by laser cutting. Fabric sections situated outside the hinge areas are severed and the plastic areas situated behind them are weakened

According to the invention, the fabric part is also injection-molded-in when the plastic substrate is produced. In order to obtain a defined position of the fabric part within the plastic substrate, the invention provides that, during the injection molding operation, the fabric part is pressed against a mold wall of the injection molding tool. On the other hand, the fabric part should be sufficiently anchored in the plastic material; that is, it must be possible for the molten plastic to penetrate through the mesh of the fabric structure during the injection molding. These two requirements are met by the mesh size and the degree of liquidity or the viscosity of the plastic material to be injection molded.

As long as the flap for the passage opening of the airbag is in one piece, one fabric part in the hinge area is basically sufficient. However, as soon as the flap consists of two or more leaves, each leaf requires a fabric part in its hinge area. In order to simplify a positioning in this case, a sufficiently large fabric part is expediently selected which covers the complete opening contour of the multipart flap and, in addition, overlaps it—for a secure anchoring.

However, in this type of a construction, it is necessary that the fabric part be severed in the area of the opening contour in a subsequent operation while leaving out the hinge areas. In an expedient embodiment of the invention, this can take place simultaneously with the working-in of the opening contour defining the dimensions of the flap. In the area of this opening contour, the plastic substrate can be severed completely. However, preferably it is only weakened by means of tear lines. The severing of the fabric part and the weakening or cutting-through of the plastic substrate expediently take place by laser beam machining.

In another advantageous embodiment of the invention, the tear lines can be produced simultaneously with the injection molding of the plastic substrate by a corresponding further development of the injection mold. In this case, the mold half situated opposite the fabric part has raised shaped-out sections which project into the injection molding chamber and copy the contour of the lid.

The hinge areas of the lid are created by the sections of the plastic substrate which are not weakened and are reinforced by the fabric part. For a clearer definition of the hinge function, according to another advantageous embodiment, the invention provides recesses which remain free of the injected plastic material. This can easily be achieved by corresponding webs on the interior side of a mold half of the injection molding tool, which webs project into the casting space. The recesses may have a width of from 3 to 7 mm, measured perpendicular to the hinge axis.

Additional details of the invention may be found in the following detailed description and the attached drawing, which illustrates a preferred embodiment of the invention as an example.

### BRIEF DESCRIPTION OF THE DRAWINGS

FIG. 1 is a view of a cutout of an interior door for a motor vehicle viewed from the interior side of the door; and

FIG. 2 is a sectional view according to FIG. 1 corresponding to the intersection line II-II.

In the case of the interior part of the motor vehicle schematically illustrated in the figures, only those parts are illustrated which are necessary for understanding the invention. It is a plastic substrate 1 with an integrated fabric part 2 illustrated in a cutout-type manner. The plastic substrate 1 is part of an interior door of a motor vehicle behind which—thus on the side facing away from the vehicle occupant compartment—an airbag unit 3 (FIG. 2) for a thorax airbag is situated.

In the illustrated cutout, the plastic substrate has a flap 4 for the passage of an airbag, which is initially stored in the airbag unit 3 and inflates in the direction of the plastic substrate 1 when the airbag unit 3 is triggered. It tears open the flap 4 along the opening contour and enters the vehicle occupant compartment. The contour of the flap 4 has an integral component of the plastic substrate is determined by tear lines 5, 6 and 7 which are arranged in an H-shape and which actually form two flap leaves 4a and 4b. As illustrated particularly in FIG. 2, the tear lines are represented by targeted weakenings of the material of the plastic substrate 1.

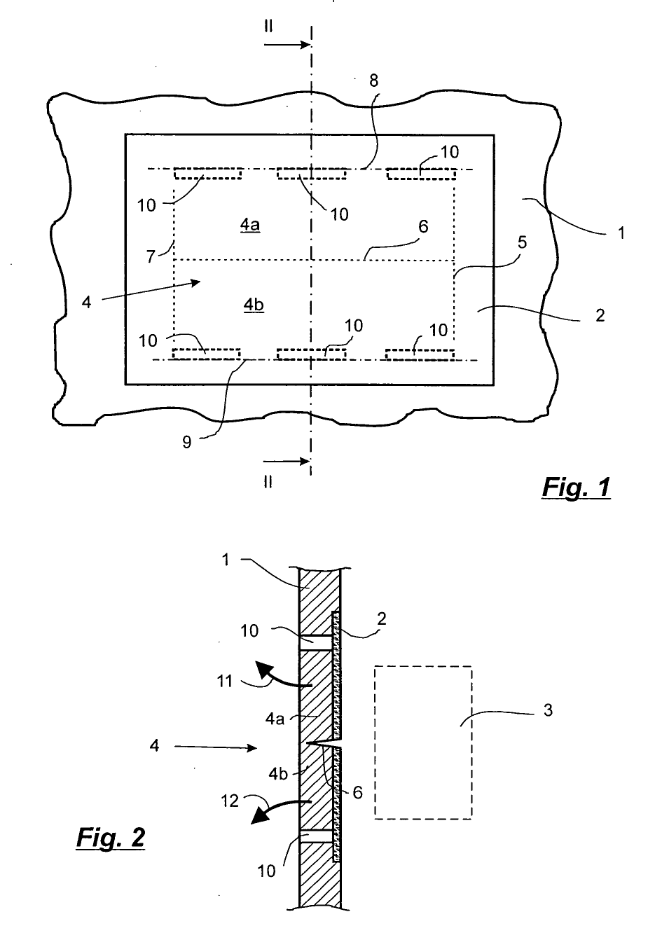

During the opening, the flap leaves 4a, 4b swivel about hinge areas whose hinge axes are outlined in FIG. 1 and have the reference numbers 8 and 9. The opening direction is indicated by two arrows 11 and 12. For defining the hinge function, several recesses 10, which are oblong in the direction of the hinge axis, are shaped into the plastic substrate 1. The recesses 10 have a width of between 3 to 7 mm—measured perpendicular to the hinge axes 8 and 9—. During the opening, the flap leaves 4a, 4b should not be torn off the plastic substrate 1. In order to reliably prevent this, the integrated fabric part 2 reinforces the hinge areas.

The plastic substrate 1 with its fabric part 2 is produced as follows. First, the fabric part 2 is positioned in the opened injection mold onto the interior side of a mold half in the area of the future flap 4. The fabric part has wide mesh structures and its dimensions are selected such that it covers the entire flap area and furthermore extends toward all sides beyond the opening contour of the future flap 4. As a result, the hinge areas to be reinforced are reliably covered. On its interior side, the other mold half has webs for forming the future recesses 10, which webs project into the casting space.

After the closing of the mold, the molten plastic is injected. In this case, the molten plastic presses the fabric part against the interior mold wall. Because of the wide mesh structures and the selected degree of viscosity of the molten material, the liquid plastic material also penetrates the fabric part and anchors it during the subsequent cooling. The molten plastic flows around the webs of the other mold half, and the recesses 10 are created.

After the injection molding, a laser device cuts the tear lines for the opening contour of the flap into the plastic substrate. In this case, the laser beam severs the fabric part at the respective points and weakens the sections of the plastic substrate situated behind it by a cut of a defined depth. On the one hand, the depth dimension is defined by the fact that, when the airbag is triggered, the plastic substrate reliably tears open along the flap contour. On the other hand, the contour should not be visible in the direction of the vehicle occupant compartment. However, as a rule, the plastic substrate is additionally also laminated with a foam-coated foil toward the side of the vehicle occupant compartment. The hinge areas are not affected by the laser beam machining; that is, neither is the fabric part severed, nor the plastic substrate weakened.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A method of producing a plastic substrate for an interior paneling part of a motor vehicle, wherein a plastic substrate with an integral flap for the passage of an airbag is produced by injection molding, the flap being swivellable in the opening direction by way of a hinge provided on the plastic substrate, and the hinge being reinforced by a fabric part, wherein the fabric part has a mesh structure, said method comprising the steps of:
inserting the hinge into an injection mold at least in the hinge area of the future flap,
closing of the mold,
forming a molten plastic for forming a plastic substrate and
injecting the molten plastic so that the molten plastic presses the fabric part against a mold wall and penetrates through the mesh structure of the fabric.

2. A method according to claim 1, wherein the fabric part is dimensioned such that it extends with edge sections beyond the opening contour of the future flap.

3. A method according to claim 1, further comprising the step of shaping the opening contour of the flap by a removal of material.

4. A method according to claim 2, wherein the fabric part and the sections of the plastic substrate situated behind it are severed in the area of the opening contour of the flap with the exception of the hinge area.

5. A method according to claim 2, further comprising the step of cutting through the fabric part in the area of the opening contour of the flap, with the exception of the hinge area and reducing the material thickness of the sections of the plastic substrate situated behind it for forming tear lines.

6. A method according to claim 3, wherein the shaping takes place by laser beam machining.

7. A method according to claim 1, further comprising the step of producing tear lines during the injection molding by raised shaped-out sections in the mold half situated opposite the fabric part, said tear lines defining the opening contour of the flap.

8. A method according to claim 1, wherein the injection mold is configured to provide recesses in the hinge area of the flap.

9. A method according to claim 8, wherein several recesses are formed in the direction of the hinge axis, and the recesses have a width of approximately 3 to 7 mm, measured perpendicular to the hinge axis.

10. A plastic substrate, produced according to the method of claim 1, which, as part of an interior paneling of a motor vehicle, has an integral two-leaf flap for the passage of an airbag upon its triggering, the hinge areas of the flap being reinforced with a fabric part which is injection-molded in the plastic substrate, with tear lines, which define the opening contour of the flap, produced by laser cutting and fabric sections situated outside the hinge areas are severed and the plastic areas situated behind them are weakened.

11. A plastic substrate according to claim 10, wherein several recesses exist along the hinge axis and have a width of approximately 3 to 7 mm, measured perpendicular to the hinge axis.
